(19) United States
(12) Patent Application Publication
(10) Pub. No.: US 2017/0248888 A1
(43) Pub. Date: Aug. 31, 2017

(54) STACKED-SHEET DETECTION DEVICE, IMAGE FORMING APPARATUS

(71) Applicant: KYOCERA Document Solutions Inc., Osaka (JP)

(72) Inventor: Sachio Izumichi, Osaka (JP)

(21) Appl. No.: 15/431,520

(22) Filed: Feb. 13, 2017

(30) Foreign Application Priority Data
Feb. 25, 2016 (JP) 2016-033846

(51) Int. Cl. G03G 15/00

(52) U.S. Cl. CPC G03G 15/5062; G03G 15/6552

(57) ABSTRACT

A stacked-sheet detection device includes a main shaft portion, a first detection arm portion, a parallel shaft portion, a second detection arm portion, an interlocking arm portion, a detected portion, and a detection sensor. The second detection arm portion is provided outside a first passing range, rotates in a predefined rotation direction and causes the interlocking arm portion to rotate in the predefined rotation direction by contacting a sheet that passes through a second passing range. When at least one of the first detection arm portion and the interlocking arm portion rotates in the predefined rotation direction, the main shaft portion rotates in the predefined rotation direction, and the detected portion rotates in the predefined rotation direction.

### INCORPORATION BY REFERENCE

This application is based upon and claims the benefit of priority from the corresponding Japanese Patent Application No. 2016-033846 filed on Feb. 25, 2016, the entire contents of which are incorporated herein by reference.

### BACKGROUND

The present disclosure relates to a stacked-sheet detection device and an image forming apparatus.

In general, an image forming apparatus discharges a sheet after image formation thereon, from a discharge port of a main body portion to a discharge tray. In addition, the image forming apparatus may include a stacked-sheet detection device configured to detect that sheets are stacked on the discharge tray in excess of a predetermined allowable level of height.

The stacked-sheet detection device may be called a fullness detection device, for example. The stacked-sheet detection device includes a rotation portion and a sensor. The rotation portion is supported so as to be rotatable around a support shaft disposed above the discharge port. The sensor detects that the rotation portion has rotated in excess of an allowable range of rotation.

When sheets are stacked on the discharge tray in excess of a predetermined level of height, the sheets push up the rotation portion. When sheets are stacked on the discharge tray in excess of the allowable level of height, the rotation portion rotates in excess of the allowable range of rotation, and the sensor detects it.

In addition, the stacked-sheet detection device may include a plurality of the rotation portions that are aligned in the width direction of the sheets with an interval therebetween. In this case, when the sheets stacked on the discharge tray push up at least one of the rotation portions, a detection arm portion rotates in interlock with the rotation of the rotation portion, and the sensor detects the rotation of the rotation portion. With this configuration, even if the sheets stacked on the discharge tray are deviated on one side in the width direction, any one of the rotation portions can detect the fullness of the sheets.

### SUMMARY

A stacked-sheet detection device according to an aspect of the present disclosure detects fullness of sheets discharged from a discharge port of a sheet conveyance path and stacked on a discharge tray. The stacked-sheet detection device includes at least one main shaft portion, a first detection arm portion, at least one parallel shaft portion, at least one second detection arm portion, at least one interlocking arm portion, a detected portion, and a detection sensor. The at least one main shaft portion is supported above the discharge port so as to be rotatable around an axis line that extends along a width direction that is perpendicular to a discharge direction of the sheets. The first detection arm portion extends from the at least one shaft portion toward the discharge tray and is configured to rotate in a predefined rotation direction around the at least one main shaft portion by being pushed up by the sheets stacked on the discharge tray. The at least one parallel shaft portion is disposed above the discharge port in parallel to the at least one main shaft portion. The at least one second detection arm portion is supported so as to be rotatable around the at least one parallel shaft portion, the at least one second detection arm portion extending from the at least one parallel shaft portion toward the discharge tray, and configured to rotate in the predefined rotation direction by being pushed up by the sheets stacked on the discharge tray. The at least one interlocking arm portion extends from the at least one main shaft portion to a surface of the at least one second detection arm portion on an opposite side from a side facing the discharge tray, and are configured to rotate around the at least one main shaft portion in the predefined rotation direction by being pushed up by the at least one second detection arm portion when the at least one second detection arm portion rotates in the predefined rotation direction. The detected portion extends from the at least one main shaft portion. The detection sensor is configured to detect the detected portion being rotated from a reference position in excess of a predetermined range in the predefined rotation direction. The first detection arm portion is provided within a first passing range which extends in the width direction and through which a first sheet having a first width passes. The at least one second detection arm portion is provided outside the first passing range and within a second passing range through which a second sheet having a second width larger than the first width passes. When the first sheet is discharged, only the first detection arm portion contacts the first sheet and rotates in the predefined rotation direction. When the second sheet is discharged, both of the first detection arm portion and the at least one second detection arm portion contact the second sheet and rotate in the predefined rotation direction.

An image forming apparatus according to another aspect of the present disclosure includes an image forming portion and the stacked-sheet detection device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus that includes a stacked-sheet detection device according to an embodiment of the present disclosure.

FIG. 2 is a perspective view of the stacked-sheet detection device according to the embodiment.

FIG. 3 is a perspective exploded view of the stacked-sheet detection device according to the embodiment.

FIG. 4 is a front view of the stacked-sheet detection device according to the embodiment.

FIG. 5 is a cross-sectional view of the stacked-sheet detection device according to the embodiment.

FIG. 6 is a side view of a detection arm portion pushed up by sheets stacked on a discharge tray.

FIG. 7 is a front view of the stacked-sheet detection device when a small-size sheet is discharged.

FIG. 8 is a side cross-sectional view of the stacked-sheet detection device when the small-size sheet is discharged.

FIG. 9 is a front view of the stacked-sheet detection device when a middle-size sheet is discharged.

FIG. 10 is a side cross-sectional view of the stacked-sheet detection device when the middle-size sheet is discharged.

FIG. 11 is a front view of the stacked-sheet detection device when a large-size sheet is discharged.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

[Configuration of Image Forming Apparatus 10]

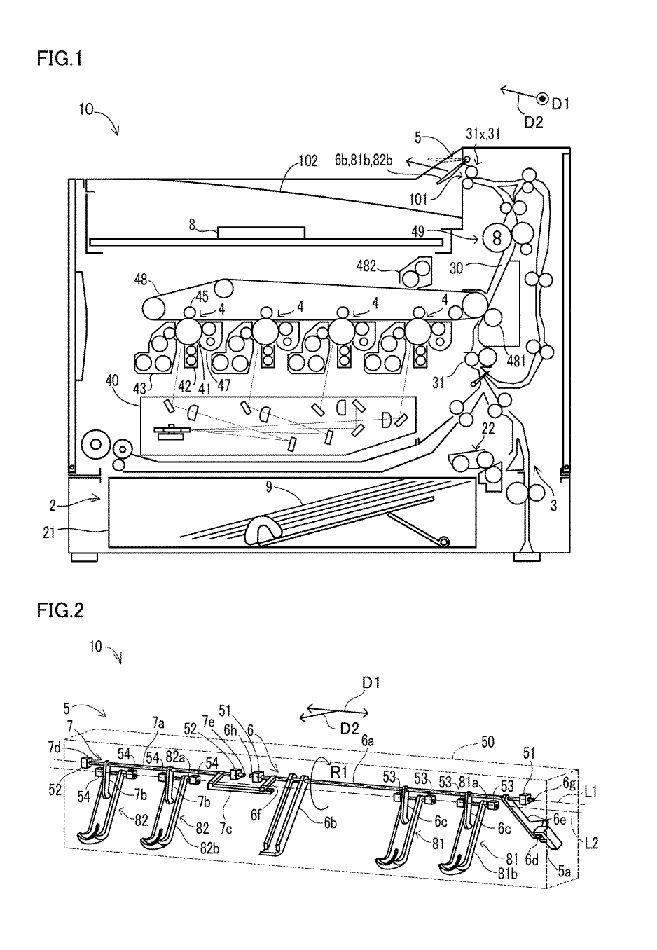

First, a description is given of a configuration of an image forming apparatus 10 according to an embodiment of the present disclosure, with reference to FIG. 1.

The image forming apparatus 10 is an electrophotographic image forming apparatus configured to form an image on a sheet 9. The sheet 9 is a sheet-like image formation medium such as a sheet of paper, an envelope, or an OHP sheet.

The image forming apparatus 10 includes a sheet supply portion 2, a sheet conveying portion 3, image generating portions 4, a laser scanning portion 40, a fixing device 49, a stacked-sheet detection device 5, and a control portion 8.

The image forming apparatus 10 shown in FIG. 1 is a tandem-type image forming apparatus. Accordingly, the image forming apparatus 10 includes a plurality of image generating portions 4 that respectively correspond to colors of cyan, magenta, yellow, and black, an intermediate transfer belt 48, a secondary transfer device 481, and a secondary cleaning device 482. The intermediate transfer belt 48 is a belt-like member formed in an annular shape, and rotates in a state of being suspended between two rollers.

In the sheet supply portion 2, a sheet feed portion 22 feeds sheets 9 one by one from a sheet cassette 21 to a sheet conveyance path 30.

The sheet conveying portion 3 includes a plurality of pairs of conveyance rollers 31 that convey the sheets 9 one by one along the sheet conveyance path 30. The plurality of pairs of conveyance rollers 31 include a pair of discharge rollers 31x that discharge the sheet 9 from a discharge port 101 onto a discharge tray 102.

The discharge port 101 is an exit of the sheet conveyance path 30. The sheet 9 discharged from the discharge port 101 onto the discharge tray 102 has an image formed thereon, and thus is a print.

As shown in FIG. 5, the pair of discharge rollers 31x are a driving roller 311 and a driven roller 312. The driving roller 311 is rotationally driven by a motor (not shown). The driven roller 312 contacts the driving roller 311 and rotates following the rotation of the driving roller 311. The driven roller 312 is pressed against the driving roller 311 by an elastic force of a spring 313.

In the following description, the width direction of the sheet 9 discharged from the discharge port 101 is referred to as a width direction D1. The width direction D1 is a horizontal direction perpendicular to a discharge direction D2 of the sheet 9, and extends along the rotation axes of the pair of discharge rollers 31x and the width of the discharge port 101. In the present embodiment, the discharge direction D2 is directed slightly upward with respect to a general horizontal direction.

In each of the image generating portions 4, a drum-like photoconductor 41 rotates and a charging device 42 uniformly charges the surface of the photoconductor 41. The laser scanning portion 40 then writes an electrostatic latent image on the charged surface of the photoconductor 41, and a developing device 43 develops the electrostatic latent image on the surface of the photoconductor 41 with toner. This allows a toner image to be formed on the surface of the photoconductor 41.

Furthermore, in each of the image generating portions 4, a primary transfer device 45 transfers the toner image from the surface of the photoconductor 41 to the intermediate transfer belt 48. As a result, a plurality of toner images are transferred from the plurality of photoconductors 41 to the intermediate transfer belt 48. With this operation, the toner images of different colors are overlaid and a color image is formed on the intermediate transfer belt 48. A primary cleaning device 47 removes toner that has remained on the surface of the photoconductor 41.

The secondary transfer device 481, in the sheet conveyance path 30, transfers the color image formed on the intermediate transfer belt 48 to the sheet 9. The secondary cleaning device 482 removes toner that has remained on the intermediate transfer belt 48.

The fixing device 49, in the sheet conveyance path 30, heats the sheet 9 to fix the color image to the sheet 9. The control portion 8 is a processor that is configured to control electric equipment included in the image forming apparatus 10.

In the image forming apparatus 10, the laser scanning portion 40, the plurality of image generating portions 4, the intermediate transfer belt 48, the secondary transfer device 481 and the fixing device 49 constitute an example of the image forming portion that forms an image on the sheet 9.

The stacked-sheet detection device 5 is provided in a region that covers an upper side and a front side of the discharge port 101. The stacked-sheet detection device 5 detects that the sheets 9 discharged from the discharge port 101 are stacked on the discharge tray 102 in excess of a predetermined allowable level of height.

[Outline of Stacked-Sheet Detection Device 5]

As shown in FIG. 2 to FIG. 5, the stacked-sheet detection device 5 includes a plurality of detection arm portions 6b, 81 and 82 and a detection sensor 5a, wherein the detection arm portions 6b, 81 and 82 are supported so as to be rotatable around support shafts provided above the discharge port 101, and the detection sensor 5a detects that the detection arm portions 6b, 81 and 82 have rotated in excess of a predetermined allowable level of rotation. It is noted that the detection sensor 5a is described below.

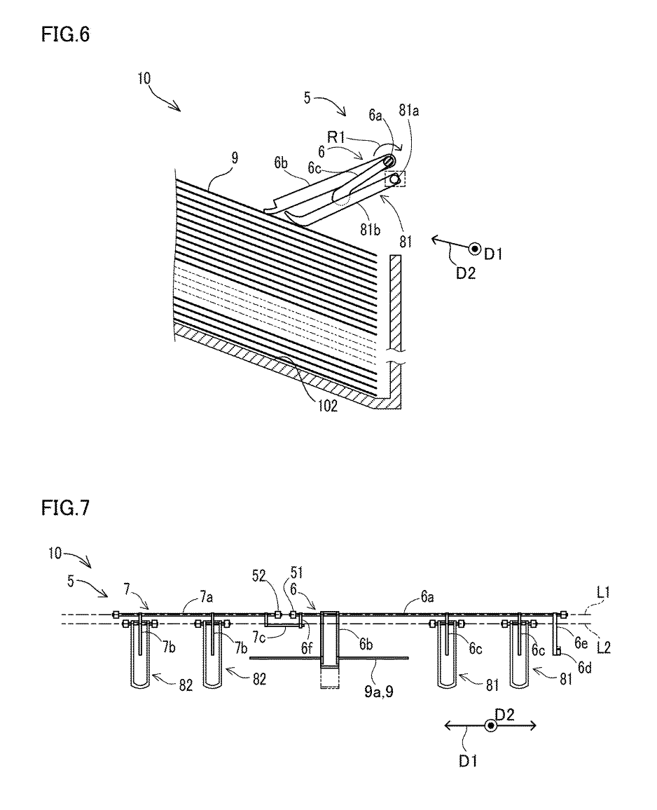

As shown in FIG. 6, the sheets 9 stacked on the discharge tray 102 push up the detection arm portions 6b, 81 and 82 when the sheets 9 are stacked in excess of a certain level of height. Thereafter, when the sheets 9 are stacked in excess of the allowable level of height, the detection arm portions 6b, 81 and 82 rotate in excess of a predetermined allowable range, and the detection sensor 5a detects that the detection arm portions 6b, 81 and 82 have rotated in excess of the allowable range.

In addition, a conventional fullness detection device may include a plurality of rotation portions that correspond to the plurality of detection arm portions 6b, 81 and 82. In this case, when sheets 9 stacked on the discharge tray 102 push up at least one of the plurality of rotation portions, the other rotation portions not contacting the stacked sheets 9 rotate in interlock with the at least one rotation portion, and the detection sensor 5a detects rotation of the rotation portions. With this configuration, even if the sheets 9 stacked on the discharge tray 102 are deviated on one side in the width direction D1, any of the plurality of rotation portions can detect the fullness of the sheets 9.

Furthermore, each sheet 9 contacts the rotation portions in the middle of a discharge from the discharge port 101 onto the discharge tray 102. At this time, the rotation portions are pushed up by the sheet 9, and the loads of the rotation portions are applied to the sheet 9. As describe below, in the stacked-sheet detection device 5, too, each sheet 9 contacts the detection arm portions 6b, 81 and 82 in the middle of a discharge.

Meanwhile, in the conventional device, a narrow-width sheet 9 may contact only one of the plurality of rotation portions when it is discharged from the discharge port 101 onto the discharge tray 102. In this case, the loads of the plurality of rotation portions are applied to one location of the sheet 9 intensively, and the sheet 9 is likely to be damaged. It is noted that as described below, in the stacked-sheet detection device 5, too, a narrow-width sheet 9 may contact only one of the plurality of detection arm portions 6b, 81 and 82.

On the other hand, in a case where only one rotation portion is provided, when the sheets 9 stacked on the discharge tray 102 are deviated on one side in the width direction D1, the fullness of the sheets 9 may not be detected.

The stacked-sheet detection device 5 has a structure that can prevent the loads of the plurality of detection arm portions 6b, 81 and 82 from being applied to one location of a sheet 9 intensively in the middle of a discharge, thereby preventing the sheet 9 from being damaged. The structure is described in the following.

[Details of Stacked-Sheet Detection Device 5]

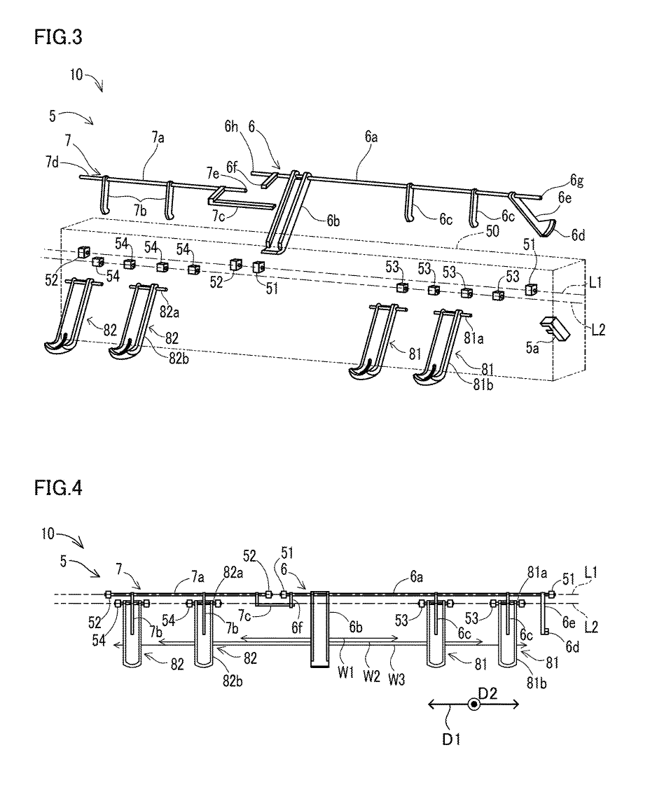

As shown in FIG. 2 to FIG. 4, the stacked-sheet detection device 5 includes a support body 50, a main rotation member 6, a relay rotation member 7, first supplementary detection arm portions 81, second supplementary detection arm portions 82, and the detection sensor 5a. It is noted that in FIG. 2 and FIG. 3, the support body 50 is schematically represented by an imaginary line.

For example, the support body 50, the main rotation member 6, the relay rotation member 7, the first supplementary detection arm portions 81, and the second supplementary detection arm portions 82 are respectively molded from synthetic resin.

The support body 50 includes first bearing portions 51, second bearing portions 52, third bearing portions 53, and fourth bearing portions 54 that are respectively fixed to predetermined positions.

The main rotation member 6 includes a first main shaft portion 6a, a main detection arm portion 6b, first interlocking arm portions 6c, a detected arm portion 6e, and a first engaging portion 6f. The first main shaft portion 6a, the main detection arm portion 6b, the first interlocking arm portions 6c, the detected arm portion 6e, and the first engaging portion 6f are integrally formed.

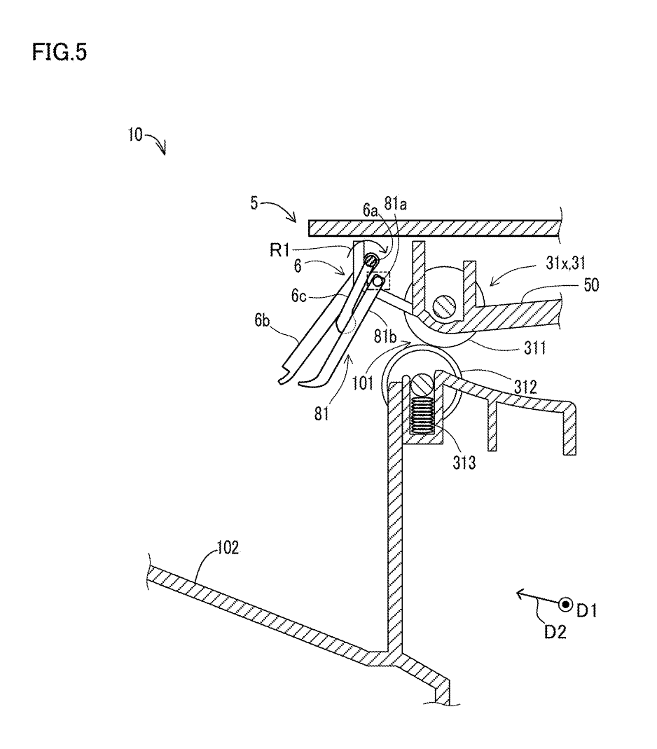

The main rotation member 6 is supported so as to be rotatable around the first main shaft portion 6a that extends along the width direction D1 above the discharge port 101. In FIG. 2, FIG. 3, FIG. 4, FIG. 7, FIG. 9, and FIG. 11, a first straight line L1 extending along the width direction D1 is represented by a dashed line. The first main shaft portion 6a is disposed along the first straight line

The first main shaft portion 6a is supported by a pair of first bearing portions 51 so as to be rotatable around the first straight line L1.

The first main shaft portion 6a is supported by the pair of first bearing portions 51 at positions close to a first end portion 6g and a second end portion 6h of the first main shaft portion 6a. The first end portion 6g of the first main shaft portion 6a is disposed to be close to an end of the discharge port 101 in the width direction D1, and the second end portion 6h of the first main shaft portion 6a is disposed to be close to a center of the discharge port 101 in the width direction D1.

The main detection arm portion 6b is formed to extend diagonally downward from the first main shaft portion 6a to a height where it blocks the front side of the discharge port 101. Here, a start position is a position at which the main rotation member 6 is positioned when the main detection arm portion 6b having no external force applied thereto extends from the first main shaft portion 6a diagonally downward in the discharge direction D2.

The main detection arm portion 6b is disposed on the first main shaft portion 6a at a position close to the second end portion 6h. As a result, one of the pair of first bearing portions 51 supports a portion of the first main shaft portion 6a that is proximate to the main detection arm portion 6b. In the present embodiment, the main detection arm portion 6b is disposed at a position close to the center of the discharge port 101 in the width direction D1.

The main detection arm portion 6b rotates in a forward rotation direction R1 around the first main shaft portion 6a by being pushed up by the sheets 9 stacked on the discharge tray 102 in excess of the certain level of height. When the main detection arm portion 6b rotates in the forward rotation direction R1, the first main shaft portion 6a also rotates in the forward rotation direction R1. It is noted that the main detection arm portion 6b is an example of the first detection arm portion. In addition, the forward rotation direction R1 is an example of the predefined rotation direction.

The detected arm portion 6e is formed to extend from the first main shaft portion 6a. When the first main shaft portion 6a rotates in the forward rotation direction R1, the detected arm portion 6e also rotates in the forward rotation direction R1. A part of the detected arm portion 6e is a light-shielding portion 6d that is a detection target of the detection sensor 5a.

The detection sensor 5a detects that the detected arm portion 6e has rotated from a reference position in excess of an allowable range. The reference position is a position at which the detected arm portion 6e is positioned when the main rotation member 6 is positioned at the start position.

The allowable range is a rotation range of the detected arm portion 6e from the reference position to a predetermined fullness detection position. The fullness detection position is a position at which the detected arm portion 6e is positioned when the main detection arm portion 6b is lifted by the sheets 9 stacked on the discharge tray 102 to the allowable level of height.

It is noted that when the main rotation member 6 is released from the contact with the sheets 9 stacked on the discharge tray 102, the main rotation member 6 returns to the start position by the own weight of the main detection arm portion 6b.

In the present embodiment, the detection sensor 5a detects the light-shielding portion 6d of the detected arm portion 6e. It is noted that the detected arm portion 6e is an example of the detected portion.

The detection sensor 5a shown in FIG. 2 is a photo interrupter (PI) sensor. The PI sensor includes a light emitting portion and a light receiving portion. A groove-like detection space is formed between the light emitting portion and the light receiving portion, and the light-shielding portion 6d is inserted in the detection space.

When the detected arm portion 6e rotates in the forward rotation direction R1 until it goes out of the allowable range, the light-shielding portion 6d moves out of the detection space, and the light receiving portion changes from a state of not receiving light to a state of receiving light from the light emitting portion. This allows the detection sensor 5a to detect the fullness of the sheets 9. It is noted that the fullness of the sheets 9 means that the sheets 9 are stacked in excess of the allowable level on the discharge tray 102.

It is noted that the detection sensor 5a may be another type of sensor such as a limit switch or a reflection-type photosensor. It is noted that the limit switch is a contact-type sensor.

When the fullness of the sheets 9 is detected by the detection sensor 5a, the control portion 8 prohibits the operation of the sheet supply portion 2 and the sheet conveying portion 3. Furthermore, the control portion 8 outputs a notification that urges the user to remove the sheets 9 from the discharge tray 102.

The first interlocking arm portions 6c of the main rotation member 6 are formed to extend from the first main shaft portion 6a to upper surfaces of the first supplementary detection arm portions 81 respectively. It is noted that the upper surfaces of the first supplementary detection arm portions 81 are the surface on an opposite side from a side facing the discharge tray.

When at least one of the main detection arm portion 6b and the first interlocking arm portions 6c rotates in the forward rotation direction R1, the first main shaft portion 6a rotates in the forward rotation direction R1, and the detected arm portion 6e rotates in the forward rotation direction R1. It is noted that the first interlocking arm portions 6c are disposed on the downstream side of the first supplementary detection arm portions 81 in the forward rotation direction R1.

The first supplementary detection arm portions 81 are supported so as to be rotatable around parallel shaft portions 81a that are disposed above the discharge port 101. The parallel shaft portions 81a are disposed in parallel to the first main shaft portion 6a. The first supplementary detection arm portions 81 are an example of the second detection arm portion that is provided in correspondence with the first main shaft portion 6a. In addition, the first straight line L1 is an example of the axis line. In FIG. 2, FIG. 3, FIG. 4, FIG. 7, FIG. 9, and FIG. 11, a second straight line L2 that is parallel to the first straight line L1 is represented by a dashed line. The parallel shaft portions 81a are disposed to extend along the second straight line L2.

Each of the first supplementary detection arm portions 81 includes the parallel shaft portion 81a and an arm portion 81b that is formed to extend downward from the parallel shaft portion 81a. The parallel shaft portion 81a and the arm portion 81b are integrally formed with each other.

Each of the parallel shaft portions 81a is formed to extend along the second straight line L2, and is rotatably supported above the discharge port 101 by a pair of third bearing portions 53 of the support body 50. That is, the first main shaft portion 6a and the parallel shaft portions 81a are parallel to each other.

Each of the first supplementary detection arm portions 81 is formed to extend downward from a position supported by the third bearing portions 53 to a height where it blocks the front side of the discharge port 101. The first supplementary detection arm portions 81 rotate in the forward rotation direction R1 when they are pushed up by the sheets 9 stacked on the discharge tray 102 in excess of the certain level of height.

It is noted that the parallel shaft portion 81a and the arm portion 81b may be formed independently of each other. In this case, the parallel shaft portion 81a is fixed to the support body 50, and the first supplementary detection arm portion 81 is supported so as to be rotatable with respect to the fixed parallel shaft portion 81a. Furthermore, instead of the parallel shaft portion 81a, a supported portion that is supported by the fixed parallel shaft portion is formed in each of the first supplementary detection arm portions 81, wherein, for example, the supported portion has a hole that is fitted to the fixed parallel shaft portion 81a.

In addition, the first interlocking arm portions 6c of the main rotation member 6 are pushed up by the first supplementary detection arm portions 81 when the first supplementary detection arm portions 81 rotate in the forward rotation direction R1. This causes the first interlocking arm portions 6c to rotate around the first main shaft portion 6a in the forward rotation direction R1.

FIG. 5 shows the main detection arm portion 6b, the first interlocking arm portions 6c, and the first supplementary detection arm portions 81 of the stacked-sheet detection device 5 when the detected arm portion 6e is positioned at the reference position. FIG. 6 shows the main detection arm portion 6b, the first interlocking arm portions 6c, and the first supplementary detection arm portions 81 of the stacked-sheet detection device 5 when the detected arm portion 6e is positioned at the fullness detection position.

The first engaging portion 6f is formed to project in a radial direction of the first main shaft portion 6a from the first main shaft portion 6a at a position close to the second end portion 6h, so as to be rotatable around the first main shaft portion 6a. The first engaging portion 6f is configured to contact a part of the relay rotation member 7. This is described below.

The relay rotation member 7 is supported so as to be rotatable around the first straight line L1. The relay rotation member 7 includes a second main shaft portion 7a, second interlocking arm portions 7b, and a second engaging portion 7c. The second main shaft portion 7a, the second interlocking arm portions 7b, and the second engaging portion 7c are integrally formed.

The second main shaft portion 7a is formed independently of the first main shaft portion 6a to extend along an extension line of the first main shaft portion 6a, on the side of the second end portion 6h of the first main shaft portion 6a. The second main shaft portion 7a is rotatably supported by the pair of second bearing portions 52 of the support body 50. That is, the first main shaft portion 6a and the second main shaft portion 7a are aligned on the same axis and supported so as to be rotatable. That is, the main shaft portion supported above the discharge port 101 so as to be rotatable around an axis line that extends along the width direction D1 includes the first main shaft portion 6a and the second main shaft portion 7a.

The second main shaft portion 7a is supported by the pair of second bearing portions 52 at positions close to a first end portion 7d and a second end portion 7e of the second main shaft portion 7a. The first end portion 7d of the second main shaft portion 7a is disposed to be close to an end of the discharge port 101 in the width direction D1, and the second end portion 7e of the second main shaft portion 7a is disposed to be close to the second end portion 6h of the first main shaft portion 6a.

The second interlocking arm portions 7b are formed to extend from the second main shaft portion 7a to upper surfaces of the second supplementary detection arm portions 82. It is noted that the second interlocking arm portions 7b are disposed on the downstream side of the second supplementary detection arm portions 82 in the forward rotation direction R1.

The second engaging portion 7c is formed to project from the second main shaft portion 7a from a position close to the second end portion 7e, and overlap with the first engaging portion 6f positioned on the upstream side in the forward rotation direction R1. The second engaging portion 7c is configured to rotate around the second main shaft portion 7a. In an example shown in FIG. 2, the second engaging portion 7c overlaps with a lower side of the first engaging portion 6f. In addition, in the example shown in FIG. 2, the second engaging portion 7c is formed in the shape of letter “L”.

When the second main shaft portion 7a rotates in the forward rotation direction R1, the second engaging portion 7c rotates around the second main shaft portion 7a in the forward rotation direction R1. With the rotation in the forward rotation direction R1, the second engaging portion 7c contacts the first engaging portion 6f and causes the first engaging portion 6f to rotate in the forward rotation direction R1.

The second supplementary detection arm portions 82 are supported so as to be rotatable around a straight line that is parallel to the first straight line L1 and is supposed to be above the discharge port 101. In the present embodiment, the second supplementary detection arm portions 82, as is the case with the first supplementary detection arm portions 81, are supported so as to be rotatable around the second straight line L2. The second supplementary detection arm portions 82 are an example of the second detection arm portion provided in correspondence with the second main shaft portion 7a.

Each of the second supplementary detection arm portions 82, as is the case with each of the first supplementary detection arm portions 81, includes a parallel shaft portion 82a and an arm portion 82b that is formed to extend downward from the parallel shaft portion 82a. The parallel shaft portion 82a and the arm portion 82b are integrally formed with each other.

The parallel shaft portion 82a is formed along the second straight line L2, and is rotatably supported above the discharge port 101 by a pair of fourth bearing portions 54. That is, the second main shaft portion 7a and the parallel shaft portions 82a are parallel to each other.

In the present embodiment, the first supplementary detection arm portions 81 and the second supplementary detection arm portions 82 are disposed symmetrically in the width direction D1 with respect to the main detection arm portion 6b. The parallel shaft portions 82a of the second supplementary detection arm portions 82 are supported on an extension line of the parallel shaft portions 81a of the first supplementary detection arm portions 81.

Each of the second supplementary detection arm portions 82 is formed to extend downward from a position supported by the fourth bearing portions 54 to a height where it blocks the front side of the discharge port 101. The second supplementary detection arm portions 82, as is the case with the first supplementary detection arm portions 81, rotate in the forward rotation direction R1 when they are pushed up by the sheets 9 stacked on the discharge tray 102 in excess of the certain level of height.

In addition, the second interlocking arm portions 7b of the relay rotation member 7 are pushed up by the second supplementary detection arm portions 82 when the second supplementary detection arm portions 82 rotate in the forward rotation direction R1. This causes the second interlocking arm portions 7b to rotate around the second main shaft portion 7a in the forward rotation direction R1.

As shown in FIG. 2, the first interlocking arm portions 6c are shorter and narrower than the first supplementary detection arm portions 81. As a result, the first interlocking arm portions 6c are lighter than the first supplementary detection arm portions 81. Similarly, the second interlocking arm portions 7b are shorter and narrower than the second supplementary detection arm portions 82. As a result, the second interlocking arm portions 7b are lighter than the second supplementary detection arm portions 82.

In the following description, a sheet 9 with the minimum width for formation of an image is referred to as a small-size sheet 9a. In addition, a sheet 9 with the maximum width for formation of an image is referred to as a large-size sheet 9c. In addition, a sheet 9 with a predetermined width between the widths of the small-size sheet 9a and the large-size sheet 9c is referred to as a middle-size sheet 9b.

Furthermore, in the stacked-sheet detection device 5, the ranges in the width direction D1 through which the small-size sheet 9a, the middle-size sheet 9b, and the large-size sheet 9c can pass are respectively referred to as a small-size range W1, a middle-size range W2, and a large-size range W3 (see FIG. 4).

It is noted that the width of the small-size sheet 9a is an example of the first size, and the widths of the middle-size sheet 9b and the large-size sheet 9c are an example of the second size. In addition, the small-size range W1 is an example of the first passing range, and the middle-size range W2 and the large-size range W3 are an example of the second passing range. In addition, the small-size sheet 9a is an example of the first sheet, and the middle-size sheet 9b and the large-size sheet 9c are an example of the second sheet.

As shown in FIG. 4, the main detection arm portion 6b is provided within the small-size range W1. In the present embodiment, the main detection arm portion 6b is provided at a center of the discharge port 101 in the width direction D1.

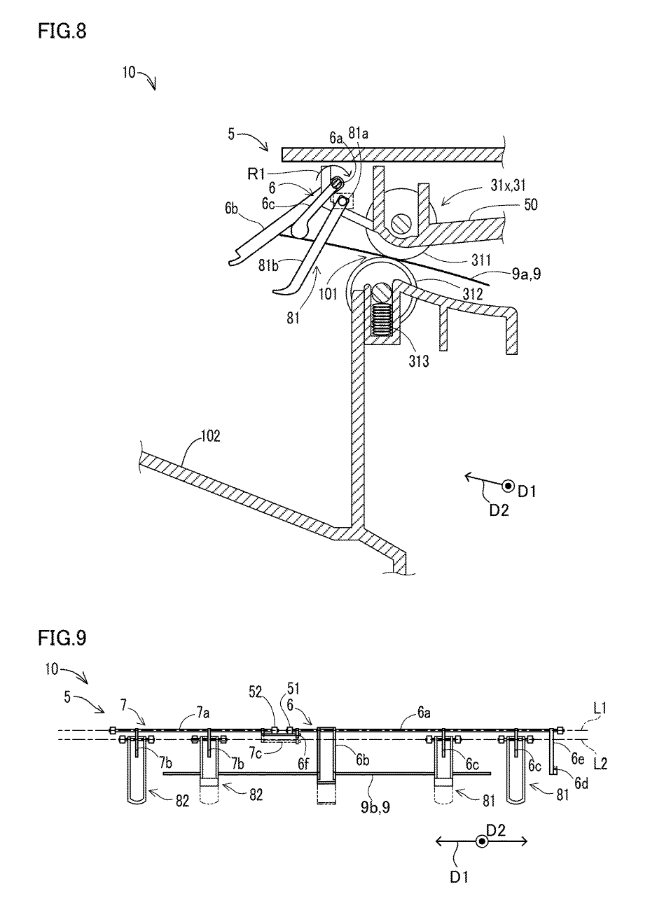

As shown in FIG. 7 and FIG. 8, the main detection arm portion 6b rotates in the forward rotation direction R1 by contacting the small-size sheet 9a that passes through the small-size range W1. When the main detection arm portion 6b rotates in the forward rotation direction R1, the first main shaft portion 6a rotates in the forward rotation direction R1, and the first interlocking arm portions 6c and the detected arm portion 6e rotate in the forward rotation direction R1. It is noted that in FIG. 7, the main detection arm portion 6b before contacting the small-size sheet 9a is represented by an imaginary line (two-dot chain line).

As shown in FIG. 4, the first supplementary detection arm portions 81 and the second supplementary detection arm portions 82 are provided outside the small-size range W1 and within the large-size range W3. As a result, when the small-size sheet 9a is discharged, among the main detection arm portion 6b, the first supplementary detection arm portions 81, and the second supplementary detection arm portions 82, only the main detection arm portion 6b rotates in the forward rotation direction R1 by contacting the small-size sheet 9a.

In the present embodiment, the first supplementary detection arm portions 81 are aligned in the width direction D1 with an interval therebetween. Similarly, the second supplementary detection arm portions 82 are aligned in the width direction D1 with an interval therebetween.

The drawings show an example where the stacked-sheet detection device 5 includes two first supplementary detection arm portions 81 and two second supplementary detection arm portions 82.

One of the two first supplementary detection arm portions 81 and one of the two second supplementary detection arm portions 82 are provided outside the small-size range W1 and within the middle-size range W2. In addition, the other of the two first supplementary detection arm portions 81 and the other of the two second supplementary detection arm portions 82 are provided outside the small-size range W1 and the middle-size range W2 and within the large-size range W3.

That is, the stacked-sheet detection device 5 includes a plurality of first supplementary detection arm portions 81 that correspond to a plurality of types of second passing ranges W2, W3 that have different widths. Furthermore, the stacked-sheet detection device 5 includes a plurality of second supplementary detection arm portions 82 that correspond to a plurality of types of second passing ranges W2, W3 that have different widths.

Furthermore, a plurality of first interlocking arm portions 6c are provided in correspondence with the plurality of first supplementary detection arm portions 81. Similarly, a plurality of second interlocking arm portions 7b are provided in correspondence with the plurality of second supplementary detection arm portions 82.

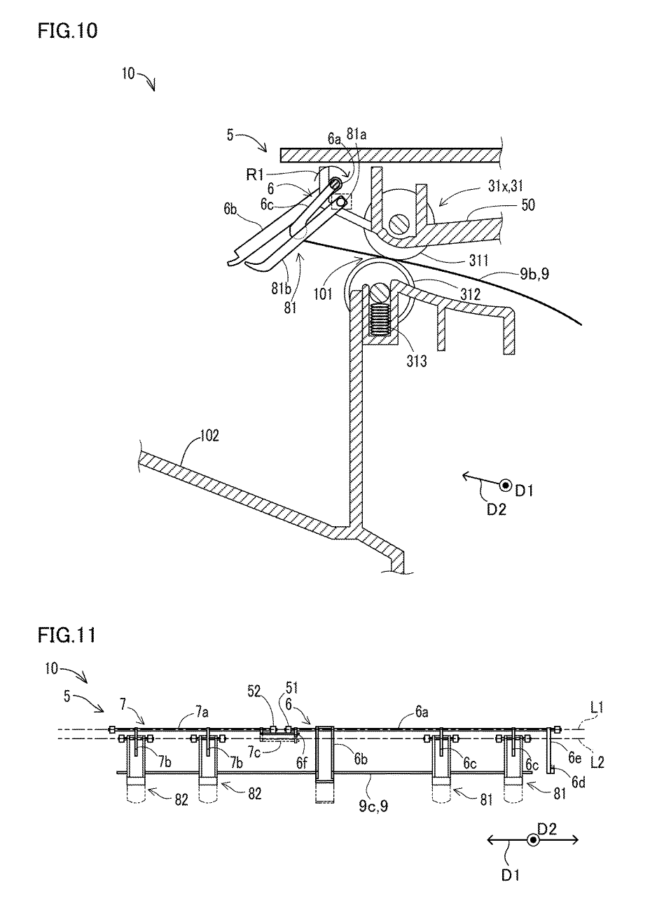

As shown in FIG. 9 and FIG. 10, one of the two first supplementary detection arm portions 81 on the main detection arm portion 6b side and one of the two second supplementary detection arm portions 82 on the main detection arm portion 6b side rotate in the forward rotation direction R1 by contacting the middle-size sheet 9b that passes through the middle-size range W2. In this case, the main detection arm portion 6b also rotates in the forward rotation direction R1 by contacting the middle-size sheet 9b. It is noted that in FIG. 9, the main detection arm portion 6b, a first supplementary detection arm portion 81, and a second supplementary detection arm portion 82 before contacting the middle-size sheet 9b are represented by imaginary lines.

In addition, as shown in FIG. 11, the other of the two first supplementary detection arm portions 81 and the other of the two second supplementary detection arm portions 82 rotate in the forward rotation direction R1 by contacting the large-size sheet 9c that passes through the large-size range W3. At this time, the main detection arm portion 6b also rotates in the forward rotation direction R1 by contacting the large-size sheet 9c. It is noted that in FIG. 11, the main detection arm portion 6b, the first supplementary detection arm portions 81, and the second supplementary detection arm portions 82 before contacting the large-size sheet 9c are represented by imaginary lines.

When at least one of the two first supplementary detection arm portions 81 rotates in the forward rotation direction R1, the rotating first supplementary detection arm portion 81 pushes up the corresponding first interlocking arm portion 6c. This causes the first interlocking arm portion 6c to rotate in the forward rotation direction R1, and the first main shaft portion 6a to rotate in the forward rotation direction R1.

Similarly, when at least one of the two second supplementary detection arm portions 82 rotates in the forward rotation direction R1, the rotating second supplementary detection arm portion 82 pushes up the corresponding second interlocking arm portion 7b. This causes the second interlocking arm portions 7b to rotate in the forward rotation direction R1, and the second main shaft portion 7a to rotate in the forward rotation direction R1.

That is, upon contacting the sheet 9 that passes through the second passing range (W2, W3), the first supplementary detection arm portions 81 rotate in the forward rotation direction R1 and cause the first interlocking arm portions 6c to rotate in the forward rotation direction R1. When the first interlocking arm portions 6c rotate in the forward rotation direction R1, the detected arm portion 6e rotates in the forward rotation direction R1.

Similarly, upon contacting the sheet 9 that passes through the second passing range (W2, W3), the second supplementary detection arm portions 82 rotate in the forward rotation direction R1 and cause the second interlocking arm portions 7b to rotate in the forward rotation direction R1. When the second interlocking arm portions 7b rotate in the forward rotation direction R1, the second engaging portion 7c causes the first engaging portion 6f to rotate in the forward rotation direction R1. This causes the detected arm portion 6e to rotate in the forward rotation direction R1.

As a result, when at least one of the main detection arm portion 6b, the first supplementary detection arm portions 81, and the second supplementary detection arm portions 82 contacts a discharged sheet 9, it rotates in the forward rotation direction R1. This causes the first main shaft portion 6a to rotate in the forward rotation direction R1, and the detected arm portion 6e to rotate in the forward rotation direction R1.

In addition, when the small-size sheet 9a is discharged, the loads of the main detection arm portion 6b and the first interlocking arm portions 6c are applied to one location of the sheet 9 that contacts the main detection arm portion 6b. However, the loads of the first supplementary detection arm portions 81 and the second supplementary detection arm portions 82 are not applied to the small-size sheet 9a. It is noted here that the load of the first interlocking arm portions 6c is very small.

In addition, when the middle-size sheet 9b is discharged, the loads of the main detection arm portion 6b, the first interlocking arm portions 6c, the second interlocking arm portions 7b, a first supplementary detection arm portion 81, and a second supplementary detection arm portion 82 are applied, in distribution, to at least two locations of the middle-size sheet 9b that contact a first supplementary detection arm portion 81 and a second supplementary detection arm portion 82. It is noted here that the loads of the first interlocking arm portions 6c and the second interlocking arm portions 7b are very small.

In addition, when the middle-size sheet 9b contacts the main detection arm portion 6b, too, the load applied to the middle-size sheet 9b is distributed to three locations that respectively contact the main detection arm portion 6b, a first supplementary detection arm portion 81, and a second supplementary detection arm portion 82.

In addition, when the large-size sheet 9c is discharged, the loads of the main detection arm portion 6b, the first interlocking arm portions 6c, the second interlocking arm portions 7b, the two first supplementary detection arm portions 81, and the two second supplementary detection arm portion 82 are applied, in distribution, to at least four locations of the large-size sheet 9c that contact the two first supplementary detection arm portions 81 and the two second supplementary detection arm portions 82.

In addition, when the large-size sheet 9c contacts the main detection arm portion 6b, too, the load applied to the large-size sheet 9c is distributed to five portions that contact the main detection arm portion 6b, the two first supplementary detection arm portion 81, and the two second supplementary detection arm portion 82.

In the stacked-sheet detection device 5 adopted, sheets 9 stacked in excess of the allowable level of height on the discharge tray 102 push up any of the main detection arm portion 6b, the first supplementary detection arm portions 81, and the second supplementary detection arm portions 82 that are aligned along the width direction D1.

As a result, even if the sheets 9 stacked on the discharge tray 102 are deviated on one side in the width direction D1, it is possible to detect the fullness of the sheets 9.

Furthermore, it is prevented that the loads of a plurality of detection arm portions 6b, 81 and 82 are applied intensively to one location of a sheet 9 being discharged. As a result, it is possible to prevent the sheet 9 from being damaged.

In addition, a plurality of first supplementary detection arm portions 81 are provided in correspondence with a plurality of types of second passing range W2 and W3 that have different widths. With this configuration, as the width of the sheet 9 increases, the load applied to the sheet 9 increases stepwisely, and the number of locations to which the load is applied increases stepwisely. This makes it possible to appropriately distribute the load applied to the sheet 9 in accordance with the size of the sheet 9.

In addition, with an arrangement where the second main shaft portion 7a is provided independently of the first main shaft portion 6a, one of the pair of first bearing portions 51 that support the first main shaft portion 6a can be disposed near the main detection arm portion 6b. This configuration makes it possible to avoid a situation where the first main shaft portion 6a is bent and the main detection arm portion 6b is deviated from an ideal position.

In addition, in the stacked-sheet detection device 5, the rotation states of the main detection arm portion 6b, the first supplementary detection arm portions 81, and the second supplementary detection arm portions 82, that correspond to different sheet widths respectively, are detected by one detection sensor 5a. With this configuration, the fullness state of the sheets 9 of a plurality of sizes can be detected by one detection sensor 5a.

### First Application Example

The relay rotation member 7, the second supplementary detection arm portions 82, and the first engaging portion 6f may be omitted from the above-described stacked-sheet detection device 5. In this case, the first main shaft portion 6a is formed in a range that covers the whole width of the discharge port 101. In addition, two first supplementary detection arm portions 81 are disposed symmetrically in the width direction with respect to the main detection arm portion 6b.

With the adoption of the first application example, too, it is possible to prevent the loads of a plurality of detection arm portions 6b and 81 from being applied intensively to one location of a sheet 9 being discharged.

### Second Application Example

One of the two first supplementary detection arm portions 81 and one of the two second supplementary detection arm portions 82 may be omitted from the stacked-sheet detection device 5.

It is noted that the stacked-sheet detection device and the image forming apparatus of the present disclosure may be configured by freely combining, within the scope of claims, the above-described embodiments and application examples, or by modifying the embodiments and application examples or omitting a part thereof.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A stacked-sheet detection device to detect fullness of sheets discharged from a discharge port of a sheet conveyance path and stacked on a discharge tray, the stacked-sheet detection device comprising:
at least one main shaft portion supported above the discharge port so as to be rotatable around an axis line that extends along a width direction that is perpendicular to a discharge direction of the sheets;
a first detection arm portion extending from the at least one main shaft portion toward the discharge tray and configured to rotate in a predefined rotation direction around the at least one main shaft portion by being pushed up by the sheets stacked on the discharge tray;
at least one parallel shaft portion disposed above the discharge port in parallel to the at least one main shaft portion;
at least one second detection arm portion that is supported so as to be rotatable around the at least one parallel shaft portion, the at least one second detection arm portion extending from the at least one parallel shaft portion toward the discharge tray, and configured to rotate in the predefined rotation direction by being pushed up by the sheets stacked on the discharge tray;
at least one interlocking arm portion extending from the at least one main shaft portion to a surface of the at least one second detection arm portion on an opposite side from a side facing the discharge tray, and configured to rotate around the at least one main shaft portion in the predefined rotation direction by being pushed up by the at least one second detection arm portion when the at least one second detection arm portion rotates in the predefined rotation direction;
a detected portion that extends from the at least one main shaft portion; and
a detection sensor configured to detect the detected portion being rotated from a reference position in excess of a predetermined range in the predefined rotation direction, wherein
the first detection arm portion is provided within a first passing range which extends in the width direction and through which a first sheet having a first width passes,
the at least one second detection arm portion is provided outside the first passing range and within a second passing range through which a second sheet having a second width larger than the first width passes,
when the first sheet is discharged, only the first detection arm portion contacts the first sheet and rotates in the predefined rotation direction, and
when the second sheet is discharged, both of the first detection arm portion and the at least one second detection arm portion contact the second sheet and rotate in the predefined rotation direction.

2. The stacked-sheet detection device according to claim 1, wherein
the at least one second detection arm portion includes a plurality of second detection arm portions that are aligned in the width direction with an interval therebetween and correspond to the second passing range, and
the at least one interlocking arm portion includes a plurality of interlocking arm portions that correspond to the plurality of second detection arm portions.

3. The stacked-sheet detection device according to claim 1, wherein
the at least one interlocking arm portion is disposed on a downstream side of the at least one second detection arm portion in the predefined rotation direction.

4. The stacked-sheet detection device according to claim 2, wherein
the at least one main shaft portion includes a first main shaft portion and a second main shaft portion that are aligned on a same axis and respectively supported so as to be rotatable,
the first main shaft portion includes a first engaging portion that projects from the first main shaft portion at a position close to an end portion of the first main shaft portion that faces the second main shaft portion,
the second main shaft portion includes a second engaging portion that projects from the second main shaft portion so as to be engaged with the first engaging portion,
the first detection arm portion and the detected portion are provided on the first main shaft portion,
one part of the plurality of interlocking arm portions is provided on the first main shaft portion, and the other part of the plurality of interlocking arm portions is provided on the second main shaft portion,
while the first detection arm portion rotates in the predefined rotation direction by coming in contact with the first sheet stacked on the discharge tray, the second main shaft portion does not rotate, and the first main shaft portion rotates in interlock with a rotation of the first detection arm portion.

5. The stacked-sheet detection device according to claim 4, wherein
while at least one of the plurality of second detection arm portions corresponding to the first main shaft portion rotates in the predefined rotation direction by coming in contact with the second sheet stacked on the discharge tray, at least one of the one part of the plurality of interlocking arm portions rotates in interlock with a rotation of the second detection arm portion, and the first main shaft portion rotates.

6. The stacked-sheet detection device according to claim 4, wherein
while at least one of the plurality of second detection arm portions corresponding to the second main shaft portion rotates in the predefined rotation direction by coming in contact with the second sheet stacked on the discharge tray, at least one of the other part of the plurality of interlocking arm portions rotates in interlock with a rotation of the second detection arm portion, and the first main shaft portion rotates as the second engaging portion is engaged with the first engaging portion.

7. The stacked-sheet detection device according to claim 2, wherein
the plurality of second detection arm portions are symmetrically disposed in the width direction with respect to the first detection arm portion.

8. An image forming apparatus comprising:
an image forming portion configured to form an image on a sheet; and
the stacked-sheet detection device according to claim 1.
